(19) United States
(12) Patent Application Publication
(10) Pub. No.: US 2008/0241450 A1
(43) Pub. Date: Oct. 2, 2008

(54) Thermoplastic Polymer Additive Compositions

(75) Inventors: Fuquan Zeng, Cowling (GB); Mark Frost, Derbyshire (GB)

Correspondence Address: PEARNE & GORDON LLP, 1801 EAST 9TH STREET, SUITE 1200, CLEVELAND, OH, 44114-3108, US

(73) Assignee: COLORMATRIX EUROPE LIMITED, Knowsley (GB)

(21) Appl. No.: 10/599,202

(22) PCT Filed: Mar. 18, 2005
(86) PCT No.: PCT/GB2005/001042

§ 371 Date: Dec. 21, 2006

(30) Foreign Application Priority Data
Mar. 23, 2004 (GB) 0406482.0

(51) Int. Cl. B32B 1/08; C08K 5/16; C08K 5/17; C08L 39/04; C08K 5/04; C08K 5/34; C08L 33/24; C08L 25/00; C08K 5/3462; C08K 5/3432

(52) U.S. Cl. 428/36.92; 524/186; 524/514; 524/502; 524/210; 524/212; 524/216; 524/516; 524/321; 524/100; 524/99

(57) ABSTRACT

Use of a hindered amine light stabiliser as an additive in a thermoplastic moulding composition comprising polyethylene terephthalate and an acetaldehyde scavenger for reducing the degree of discolouration and/or degree of light transmission of a moulded article formed from the composition.

This application claims the benefit of International Application Number PCT/GB2005/001042, which was published in English on Oct. 6, 2005.

This invention relates to thermoplastic polymer additive compositions and their use. In particular it relates to such additive compositions that are useful as colour stabilizers for thermoplastic molding compositions and thermoplastic materials, especially when such materials are recycled.

Polyethylene terephthalate is widely employed in the manufacture of packaging items. One large application for polyethylene terephthalate is in the manufacture of food packaging items and, in particular, beverage bottles. Such beverage bottles are extensively utilised for carbonated soft drinks and are increasingly more attractive, for safety considerations, in the packaging of alcoholic beverages such as beer. Bottles used for still or carbonated water or other soft drinks are typically colourless, green or blue. However, this invention is particularly, although not exclusively, concerned with colourless and near-colourless bottles.

Other uses for polyethylene terephthalate molding compositions include the manufacture of packages for agrochemicals, cosmetics, detergents and the like.

Polyethylene terephthalate bottles are usually manufactured using a two stage process. Granules of the polyethylene terephthalate, along with any relevant additives, are injection molded in a first step to produce a preform. The resulting preform is then blow molded, possibly at a different factory, in a second step to the desired shape. Machines are also available which make bottle preforms and then blow them immediately into bottles.

Typical temperatures required for injection molding of polyethylene terephthalate molding compositions are between about 260° C. and about 285° C. or higher, e.g. up to about 310° C. Somewhat lower temperatures in excess of about 100° C. up to about 170° C. or more are generally used in the blow-molding step to produce a bottle from a polyethylene terephthalate preform.

It is a recognised phenomenon within the industry that use of extended dwell times at elevated temperatures, particularly during the injection molding step used to make a polyethylene terephthalate bottle preform but also possibly during the subsequent blow molding step, may tend to result in an inferior colouration of the preform or blow molded bottle, in particular by yellowing of colourless materials, and/or inferior light transmission (e.g. haze, clearness or clarity) properties.

It is further recognised that, with an increase in usage of polyethylene terephthalate and other thermoplastic materials for manufacture of packaging and other articles, a greater need arises to address the problem of disposal of the waste material. With land fill space becoming evermore scarce and with society being generally more environmentally aware than ever before, there is an increasing demand that the recycling option be taken. A limited amount of recycled polyethylene terephthalate material is already employed to produce strapping for packaging. Recycled polyethylene terephthalate is also used in the fibre industry to provide such products as wadding and sound insulation for cars and carpets. However, a more satisfactory option would be to recycle colourless or substantially colourless packaging of a sufficient quality such that it may be reused for food or drink applications. Presently, colourless polyethylene terephthalate material may be recycled or reused either with or without the addition of colouring. However, the recycling of colourless polyethylene terephthalate can give rise to a yellowing of the recycled material. The light transmission properties (e.g. haze, clearness or clarity) of the recycled material may also be unsatisfactory compared to the original material.

Other thermoplastic materials that are in widespread use include polyolefins, such as polyethylene and polypropylene, and polyvinyl chloride. However, this invention is concerned only with polyethylene terephthalate.

It would be desirable to be able to recycle previously used colourless or substantially colourless polyethylene terephthalate in order to produce a material whose colour would permit it to be recycled for further use, for example as a recycled, colourless or substantially colourless, polyethylene terephthalate bottle.

There is a need to provide a thermoplastic polymer additive composition for incorporation into polyethylene terephthalate molding compositions that will stabilize the colour of the polyethylene terephthalate on injection molding and/or on recycling. There is a further need to provide a substantially colourless polyethylene terephthalate molding composition that, after having been formed into bottles or other molded articles, is suitable for recycling to make further bottles or other articles of a commercially acceptable colour.

There is a further need to provide colourless or substantially colourless blow molded articles, such as bottles, and colourless or substantially colourless preforms therefor, which exhibit good gas barrier properties and which provide protection for the contents against ultra-violet light, and which have a good recycling potential.

It is an object of the present invention to provide recycling potential to colourless articles made from polyethylene terephthalate where that has not been possible or desirable previously due to restrictions placed upon the utility of the recycled material as a result of its colour and/or light transmission properties.

According to a first aspect of the present invention there is provided a thermoplastic polymer additive composition for addition to a thermoplastic molding composition, said additive composition comprising at least one hindered amine light stabilizer and at least one acetaldehyde scavenger.

Preferably, the additive composition is such that when it is added to a molding composition (and a 2.5 mm thick plaque is made as described in Example 1 hereinafter), the % transmission at 450 nm and/or 550 nm of the molding composition which includes the additive composition (e.g. the plaque) is greater than the % transmission measured in an identical manner on an identical material (e.g. plaque) except that such material does not include a hindered amine light stabilizer.

It is postulated that the deleterious effects on light transmission and/or on colour properties of polyethylene terephthalate molded articles apparently caused by acetaldehyde scavengers can be mitigated by the inclusion in the melt of a hindered amine light stabilizer. Accordingly, in a second aspect, the present invention provides the use of a hindered amine light stabilizer as an additive in a polyethylene terephthalate molding composition comprising an acetaldehyde scavenger to reduce discolouration and/or haze and/or increase the degree of light transmission after molding of the composition. The molding composition may be a recyclate, in which case the use of a hindered amine light stabilizer is thought to be particularly effective in reducing discolouration and/or haze, which may occur as a result of solid stating procedures used during recycling.

In a third aspect, the invention extends to a method of increasing the degree of light transmission after molding of a polyethylene terephthalate molding composition comprising an acetaldehyde scavenger, the method comprising including a hindered amine light stabilizer as an additive in the molding composition.

The hindered amine light stabilizer and the acetaldehyde scavenger may be added concurrently to a molding composition; or hindered amine light stabilizer may be added to a molding composition which already includes a said acetaldehyde scavenger. In a less preferred embodiment, an acetaldehyde scavenger may be added to a molding composition which already includes a hindered amine light stabilizer.

An increase in the degree of light transmission in accordance with the second and third aspects may be confirmed by comparing the % transmission (at 450 nm and/or 550 nm) after molding a said molding composition which includes a said hindered amine light stabilizer as a said additive, to a molding composition which is equivalent in all respects except that it does not include a said hindered amine light stabilizer.

An increase in the degree of light transmission may be confirmed using the procedure set forth in Example 1 hereinafter.

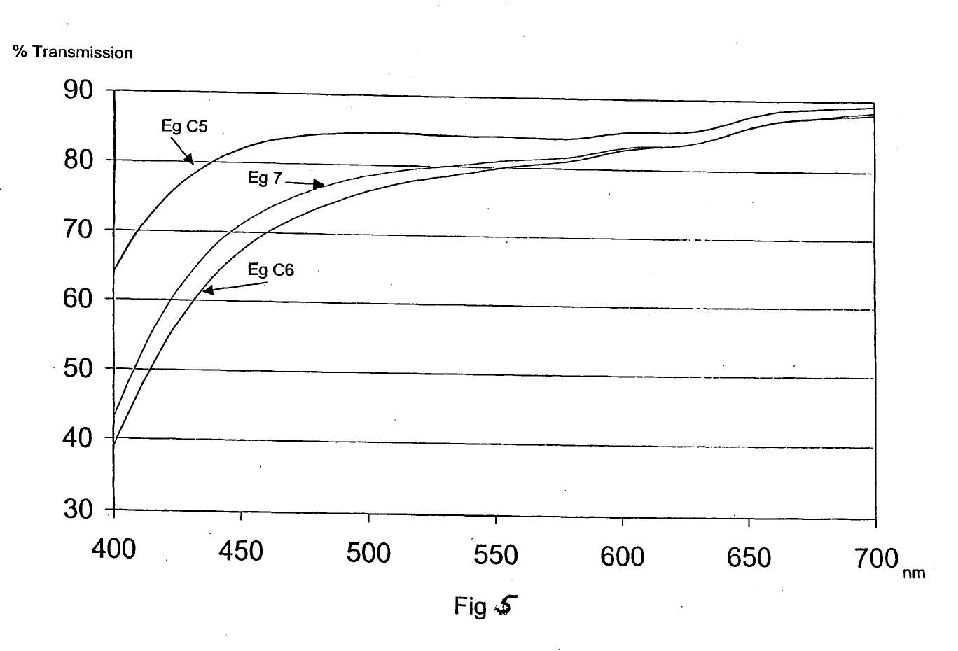

Preferably, inclusion of the hindered amine light stabilizer results in an increase in the degree of light transmission (of for example a plaque) after molding across at least 50% (preferably at least 60%, more preferably at least 70%, especially at least 80%) of the wavelength range 400-600 nm. An increase as aforesaid will be readily apparent from a plot of % transmission against wavelength, for example as shown in FIGS. 5 to 7 hereinafter.

It has been found that hindered amine light stabilizers are capable of acting synergistically with acetaldehyde scavengers to reduce acetaldehyde content. Accordingly, in a fourth aspect, the invention further provides the use of a hindered amine light stabilizer as an additive in a thermoplastic molding composition comprising polyethylene terephthalate and an acetaldehyde scavenger for, synergistically with the acetaldehyde scavenger, reducing the acetaldehyde content of a molded article formed from the composition

The thermoplastic polymer additive composition of the invention may be provided in a form suitable for direct addition to a thermoplastic melt or pre-melt granular composition. For example, the thermoplastic polymer additive composition may be uniformly dispersed in an inert liquid carrier therefor.

The thermoplastic molding composition is preferably one that tolerates or requires high temperature processing conditions, for example use of an injection molding temperature of at least about 200° C. Suitable materials include polyethylene terephthalate.

In order to mold articles from a thermoplastic molding composition it is necessary to heat the composition to a temperature above its softening point. However, it is normally preferred to perform molding at a temperature below the melting point of the thermoplastic polymer material present in the thermoplastic molding composition. In the practice of the present invention, it will often be preferred to utilise thermoplastic polymer materials in the molding composition which can tolerate, or which require the use of, high processing temperatures, for example temperatures of at least about 200° C. Some molding processes may require the use of more severe processing conditions than others. For example, in the formation of a blow molded polyethylene terephthalate bottle, injection temperatures in the range of from about 260° C. to about 285° C. or more, e.g. up to about 310° C., can be used in the course of forming a bottle preform whereas a lower temperature of, for example, from about 100° C. up to about 170° C. is typically used, in combination with a suitable high air pressure of, for example, about 40 bar, in order to blow a bottle of the desired shape from the bottle preform.

Mechanical recycling procedures may involve the following steps:
1. Collection (e.g. of bottles). This is usually organised through bottle collection points and some times by street collection.
2. Colour sorting. This is often done manually although more in-line automated systems are becoming available. The commercial value of polyethylene terephthalate coloured bottles is: clear>blue>green>amber/other transparent and translucent colours>opaque. Clear, blue and green can be blended to give an acceptable final resin colour. Other colours find use either in strapping and staple fibre. There are also some applications in crates and pallets. The recycling of colourless or substantially colourless bottles to produce recycled colourless or substantially colourless bottles has been difficult because of the tendency of the recycled materials to yellow and/or become hazy.
3. Grinding. Typically the bottles are ground into fragments of typical thickness 0.15 to 0.4 mm in size of approximately 1 to 2 cm.
4. Separation of polyethylene terephthalate from contaminants. This is usually done by flotation or other means such as air separation. This removes closures, labels, internal barrier layers, soil etc.
5. Washing. Typical composition of a wash is 1.8% sodium hydroxide. Bottles are typically washed at 80° to 85° C. This removes external barrier layers, plus more importantly, microbiological material and potentially toxic compounds.
6. Drying. Usually by hot air.
7. Extrusion and pelletizing. A vacuum pump is employed to remove volatiles.
8. Solid stating. This is usually conducted by convected heating and 200° C. for 8 to 12 hours, or longer—for example up to about 16 hours or even more. This increases the IV to the required level. For bottle blowing this is typically 0.72-0.84 dL/g.

The solid stating procedure in recycling has tended to cause a yellowing in polyethylene terephthalate materials, particularly in such materials that contain an acetaldehyde scavenger. It has now been discovered that in the recycling of a polyethylene terephthalate material that comprises an acetaldehyde scavenger, the addition to the recyclates of a hindered amine light stabilizer before the solid stating step can reduce this problem.

Said hindered amine light stabilizer suitably includes a piparazine or a piperidine moiety. Said hindered amine light stabilizer preferably includes a moiety of formula I or II.

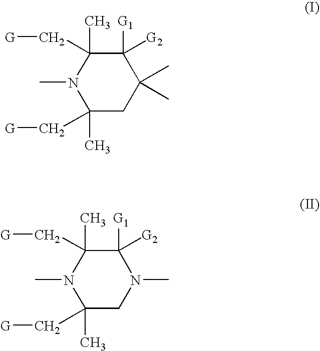

wherein

G is hydrogen, methyl or a linking atom or group and

G₁ and G₂ are hydrogen, methyl, a linking atom or group or together are oxygen.

Preferably, G is hydrogen or methyl; and G₁ and G₂ are hydrogen or methyl.

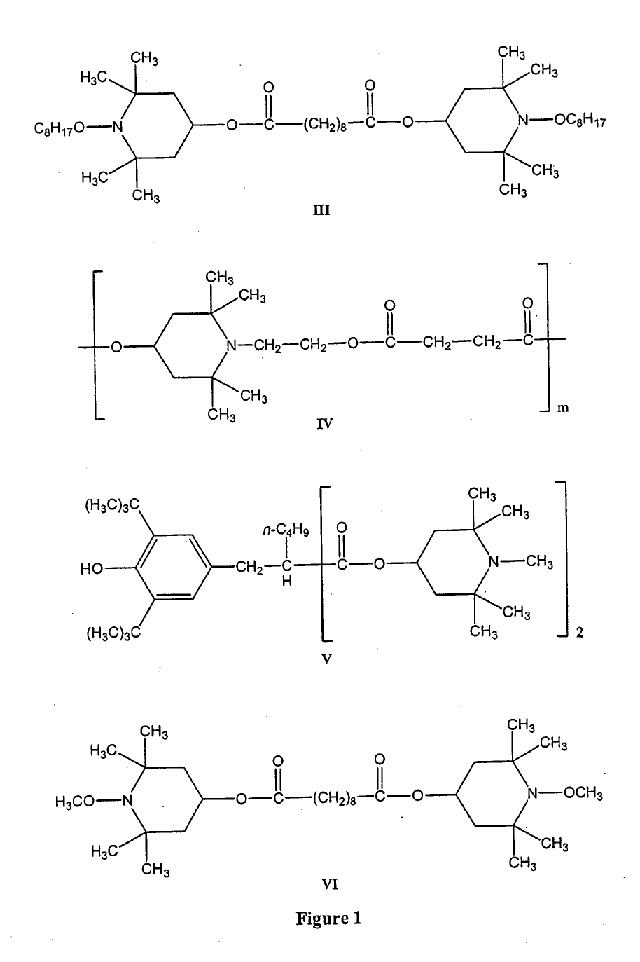

Hindered amine light stabilizers may be selected from compounds III to XVIII shown in FIGS. 1 to 4 wherein n and m are integers with m being in the range 2 to 200 and n suitably being in the range 2 to 5.

Preferred hindered amine light stabilizers suitable for use in the present invention include: Chimassorb™ 944 (CAS No. 71878-19-8), also known as poly[6-[(1,1,3,3-tetramethylbutyl)amino]1,3,5-triazine-2,4-diyl]-[(2,2,6,6-tetramethyl-4-piperidyl)-imino]hexamethylene[(2,2,6,6-tetramethyl-4-piperidyl)imino], Chimassorb™ 2020 (CAS No. 192268-64-7), also known as poly-[[6-[N-(2,2,6,6-tetramethyl-4-piperidinyl)-n-butylamino]-1,3,5-triazine-2,4-diyl][(2,2,6,6-tetramethyl-4-piperidinyl)imino]-1,6-hexanediyl[2,2,6,6-tetramethyl-4-piperidinyl)imino]]-alpha-[N,N,N′,N′-tetrabutyl-N″-(2,2,6,6-tetramethyl-4-piperidinyl)-N″-[2,2,6,6-tetramethyl-4-piperidinylamino)-hexyl]-[1,3,5 triazine-2,4,6-triamine]omega-N,N,N′,N′-tetrabutyl-1,3,5-triazine-2,4-diamine, Tinuvin™ 622 (CAS No. 65447-77-0), Tinuvin™ 770 (Cas No. 52829-07-9), also known as sebacic acid, bis(2,2,6,6-tetramethyl-4-piperidyl)ester, and Cyasorb™ UV3346 (CAS No. 082451-48-7), also known as poly(6-morpholino-1,3,5,-triazine-2,4,-diyl)[(2,2,6,6-tetramethyl-4-piperidyl)imino]-hexamethylene-[(2,2,6,6-tetramethyl-4-piperidyl)-imino].

Preferred hindered amine light stabilizers include a piperidine moiety. Preferred stabilizers include a moiety I referred to above. In moiety I, preferably each G represents a hydrogen atom and G₁ and G₂ represent hydrogen atoms. Said stabilizers preferably include a —(CH₂CH₂)ₚ— moiety where p is in the range 1 to 10, preferably 1 to 6. Suitably, they have an average molecular weight (Mn) in the range 300 to 10000, preferably in the range 500 to 7000, more preferably in the range 1000 to 5000, especially in the range 1300 to 4000.

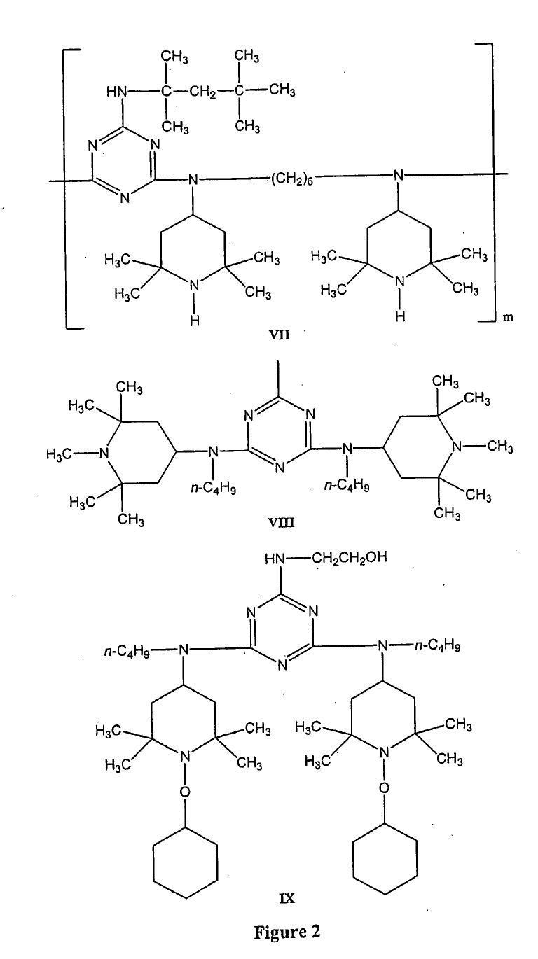

An especially preferred hindered amine light stabilizer is CHIMASSORB 944 (compound VII shown in FIG. 2).

Preferred acetaldehyde scavengers include one or more nitrogen atoms. Preferably, the nitrogen atoms are not bonded to other atoms by double or triple bonds, but are preferably bonded to three other atoms by single bonds. Preferred scavengers include amine moieties. Preferred amine moieties are primary and secondary amine moieties. Especially preferred are scavengers which include a —NH₂ moiety.

In one embodiment, preferred acetaldehyde scavengers include both amine moieties as described and amide moieties. In one embodiment, preferred acetaldehyde scavengers include a substituted phenyl moiety. In one preferred embodiment, a said acetaldehyde scavenger may include an amine moiety (especially —NH₂), an amide moiety (especially —CONH₂) and a substituted phenyl moiety. In this case, it is preferred that both the amine moiety and the amide moiety are directly bonded to the phenyl moiety. Preferably, the amine moiety and amide moiety are bonded ortho to one another.

One class of acetaldehyde scavengers may be as described in U.S. Pat. No. 5,340,884 (Eastman), the content of which as regards the scavengers is incorporated herein by reference. In this case, the scavenger may be a polyamide selected from the group consisting of low molecular weight partially aromatic polyamides having a number average molecular weight of less than 15,000, low molecular weight aliphatic polyamides having a number average molecular weight of less than 7,000, and combinations thereof. Preferred low molecular weight partially aromatic polyamides include: poly(m-xylylene adipamide), poly(hexamethylene isophthalamide), poly(hexamethylene adipamide-co-isophthalamide), poly(hexamethylene adipamide-co-terephthalamide), and poly(hexamethylene isophthalamide-co-terephthalamide). The most preferred low molecular weight partially aromatic polyamide is poly(m-xylylene adipamide) having a number average molecular weight of 4,000 to 7,000 and an inherent viscosity of 0.3 to 0.6 dL/g. Preferred low molecular weight aliphatic polyamides include poly(hexamethylene adipamide) and poly(caprolactam). The most preferred low molecular weight aliphatic polyamide is poly(hexamethylene adipamide) having a number average molecular weight of 3,000 to 6,000 and an inherent viscosity of 0.4 to 0.9 dL/g.

Another class of acetaldehyde scavengers may be as described in U.S. Pat. No. 6,762,275 (Coca-Cola), the content of which as regards the scavenger is incorporated herein by reference. In this case, the scavenger may include at least two component molecular fragments, each component molecular fragment comprising at least two hydrogen substituted heteroatoms bonded to carbons of the respective component molecular fragment. The component molecular fragments of the organic additive compound are each reactive with acetaldehyde in a polyester to form water and a resulting organic molecular fragment comprising an unbridged five or six member ring including the at least two heteroatoms. Preferably, the organic additive compounds have at least twice the molecular weight of the component molecular fragments alone. The heteroatoms present in each molecular fragment capable of reacting with acetaldehyde include oxygen (O), nitrogen (N), and sulfur (S). The heteroatoms of the component molecular fragments suitably have at least one bond to an active hydrogen (H), and in the course of condensing with acetaldehyde should split off water. Preferred functional groups containing these heteroatoms include amine (NH2 and NHR), hydroxyl (OH), carboxyl (CO2H), amide (CONH2 and CONHR), sulfonamide (SO2NH2), and thiol (SH). It is necessary for these functional groups to be sterically arranged so that on condensation with AA an unbridged 5 or 6 member ring can be formed. It is preferred that the structural arrangement allows the formation of a six membered ring. It is especially preferred that heteroatoms of the organic additive are attached to a preformed ring or rings. It is most preferred that the preformed ring(s) are aromatic so that the unbridged 5 or 6-member ring of the resulting organic compound is bonded to the aromatic ring. Suitable organic additive compounds may be substantially thermally stable at the temperatures required for melt-processing the polyester. It is also preferred that the functional groups present on the organic additive are relatively unreactive towards the ester linkages present in polyesters. Examples of preferred scavengers include 1,2-bis(2-aminobenzamidoyl)ethane; 1,2-bis(2-aminobenzamidoyl)propane; 1,3-bis(2-aminobenzamidoyl)propane; 1,3-bis(2-aminobenzamidoyl)pentane; 1,5-bis(2-aminobenzamidoyl)hexane; 1,6-bis(2-aminobenzamidoyl)hexane; and 1,2-bis(2-aminobenzamidoyl)cyclohexane. More preferred are scavengers where the component molecular fragments are derived from anthranilamide, because of their low cost, efficacy, and ease of incorporation into PET.

An especially preferred scavenger of said class is 1,6-bis(2-aminobenzamidoyl hexane).

Another group of acetaldehyde scavengers suitable for use in the present invention include Anthranilamide, 1,8-diaminonaphalene, Allantoin, 3,4-diaminobenzoic acid, Malonamide, Salicylanilide, 6-amino-1,3-dimethyluracil (DMU), 6-Aminoisocytosine, 6-Aminouracil, 6-Amino-1-methyluracil, α-tocopherol, triglycerin, trimethylolpropane, dipentaerythritol,tripentaerythritol,D-mannitol, D-sorbitol, and xylitol. From the aforementioned group, Anthranilamide, 1,8-diaminonaphalene, Allantoin, 3,4-diaminobenzoic acid, Malonamide, Salicylanilide, 6-amino-1,3-dimethyluracil (DMU), 6-Aminoisocytosine, 6-Aminouracil, 6-Amino-1-methyluracil are preferred.

Preferably, a said hindered amine light stabilizer is selected from a compound which includes moiety I wherein each of G, G₁ and G₂ represent hydrogen atoms; and a said acetaldehyde scavenger is selected from Anthranilamide, 1,8-diaminonaphalene, Allantoin, 3,4-diaminobenzoic acid, Malonamide, Salicylanilide, 6-amino-1,3-dimethyluracil (DMU), 6-Aminoisocytosine, 6-Aminouracil, 6-Amino-1-methyluracil, 1,2-bis(2-aminobenzamidoyl)ethane, 1,2-bis(2-aminobenzamidoyl)propane, 1,3-bis(2-aminobenzamidoyl)propane, 1,3-bis(2-aminobenzamidoyl)pentane, 1,5-bis(2-aminobenzamidoyl)hexane, 1,6-bis(2-aminobenzamidoyl)hexane and 1,2-bis(2-aminobenzamidoyl)cyclohexane.

Preferably, the thermoplastic molding composition comprises a polyester, especially polyethylene terephthalate. Polyethylene terephthalate used for injection molding purposes is typically post-condensed and has a molecular weight in the region of about 25,000 to 30,000. However, it has also been proposed to use a fibre grade polyethylene terephthalate that is cheaper but is non-post-condensed, with a lower molecular weight in the region of about 20,000. It has further been suggested to use co-polyethylene terephthalates of polyethylene terephthalate which contain repeat units from at least 85 mole % terephthalic acid and at least 85 mole % of ethylene glycol. Dicarboxylic acids which can be included, along with terephthalic acid, are exemplified by phthalic acid, isophthalic acid, naphthalene-2,6-dicarboxylic acid, cyclohexanedicarboxylic acid, cyclohexanediacetic acid, diphenyl-4,4′-dicarboxylic acid, succinic acid, glutaric acid, adipic acid, azelaic acid and sebacic acid. Other diols which may be incorporated in the co-polyethylene terephthalates, in addition to ethylene glycol, include diethylene glycol, triethylene glycol, 1,4-cyclohexanedimethanol, propane-1,3-diol, butane-1,4-diol, pentane-1,5-diol, hexane-1,6-diol, 3-methylpentane-2,4-diol, 2-methyl pentane-1,4-diol, 2,2,4-trimethylpentane-1,3-diol, 2-ethylhexane-1,3-diol, 2,2-diethylpropane-1,3-diol, hexane-1,3-diol, 1,4-di(hydroxyethoxy)-benzene, 2,2-bis-(4-hydroxycyclohexyl)-propane, 2,4-dihydroxy-1,1,3,3-tetramethyl-cyclobutane, 2,2-bis-(3-hydroxyethoxyphenyl)-propane, and 2,2-bis-(4-hydroxypropoxyphenyl)-propane. In this specification the term “polyethylene terephthalate” includes not only polyethylene terephthalate but also such co-polyethylene terephthalates.

Injection molding of polyethylene terephthalate and other polyethylene terephthalate molding compositions is typically carried out using an injection molding machine and a maximum barrel temperature in the range of from about 260° C. to about 285 C or more, for example, up to about 310° C. The dwell time at this maximum temperature is typically in the range of from about 15 seconds to about 5 minutes or more, preferably from about 30 seconds to about 2 minutes.

It is well known within the industry that polyethylene terephthalate does not exhibit good gas barrier properties. When producing bottles that will be used to package carbonated drinks or alcoholic beverages it is desirable to prevent carbon dioxide from escaping and being replaced by oxygen. It has accordingly been proposed to add a polyamide to the thermoplastic polyethylene terephthalate molding composition in order to confer improved gas barrier properties on it. Alternatively a sandwich construction may be used in which nylon or an ethylene/vinyl alcohol resin is incorporated in a multi-layer preform which is then blow molded to form a bottle having improved gas barrier properties.

The thermoplastic polymer additive of the invention may be added as a solid masterbatch in the form of granules or powder. Alternatively, the additive may be suspended or dissolved in a liquid carrier in order to ensure a uniform dispersion of the additive throughout the polyethylene terephthalate. The liquid carrier is generally an inert material, such as a hydrocarbon oil, an ester, an alcohol, or a mixture of two or more thereof. The liquid carrier is selected to be non-toxic, to have good compatibility with polyethylene terephthalate and to possess good solvent properties (if the additive is to be dissolved in the liquid carrier). Ideally, the quantity of carrier included in the composition is kept to a minimum in order that the properties of the polyethylene terephthalate are not adversely affected. The thermoplastic polymer additive composition of the present invention may include a thermoplastic polymer-compatible organic liquid carrier. Such a carrier must be compatible with the thermoplastic polymer material of the thermoplastic molding composition and is preferably also compatible with the other components to be included in the thermoplastic molding composition of the invention. Typical carriers include hydrocarbons, hydrocarbon mixtures, alcohols, esters and mixtures of two or more thereof. Preferably the thermoplastic polymer-compatible organic liquid carrier is an oil based vehicle. Examples of such vehicles of the materials available as Clearslip™ 2 and Clearslip™ 3 from ColorMatrix Europe Ltd., of Unit 9-11, Unity Grove, Knowsley Business Park, Knowsley, Merseyside, L34 9GT.

The thermoplastic polymer additive composition may also include one or more further functional additives. The sum of the amounts of said further additives preferably comprises less than 5 wt %, preferably less than 2 wt %, more preferably less than 1 wt % of said additive composition.

The ratio of the weight of said acetaldehyde scavenger to the weight of hindered amine light stabilizer used in compositions referred to herein (e.g. used in the additive composition of the first aspect or in a dispersion, masterbatch or molding composition) is suitably at least 1, preferably is at least 2, more preferably is at least 3 and, especially is at least 4. The ratio may be less than 30, preferably less than 20, more preferably less than 10. Suitably, the ratio is in the range 2 to 10, preferably 3 to 8, more preferably 4 to 7.

In a molding composition, for example comprising PET described herein, the amount of acetaldehyde scavenger in the composition may be in the range 0.01 to 2.0 wt %, preferably in the range 0.01 to 0.2 wt %, more preferably in the range 0.01 to 0.05 wt %. The amount of hindered amine light stabilizer may be in the range 0.002 to 0.040 wt %, preferably in the range 0.002 to 0.01 wt %.

A mixture comprising acetaldehyde scavenger and hindered amine light stabilizer may be provided in a concentrated form, for example in the form of a masterbatch comprising solid material for mixing with a molding composition or in the form of a solution or suspension. In such concentrated forms, the sum of the wt % of acetaldehyde scavengers and hindered amine light stabilizers may be less than 50 wt %, preferably less than 40 wt % of the concentrated form; but preferably makes up at least 5 wt % of the concentrated form. When a liquid dispersion is provided, the sum of the wt % of acetaldehyde scavengers and hindered amine light stabilizers in the dispersion may be in the range 20 to 50 wt %, preferably 35 to 45 wt %. In a solid masterbatch, the sum of the wt % of acetaldehyde scavengers and hindered amine light stabilizers may be in the range 8 to 30 wt %.

When compositions include more than one type of acetaldehyde scavenger and/or more than one type of hindered amine light stabilizer, ratios and/or wt % referred to herein suitably refer to the sum of the amounts of scavengers and stabilizers as appropriate. Preferably, however, compositions include only a single type of acetaldehyde scavenger; and preferably include only a single type of hindered amine light scavenger.

In one embodiment, the amount of hindered amine light stabilizer used in the thermoplastic molding composition of the invention is preferably less than 1000 ppm, more preferably less than 500 ppm, even more preferably less than about 250 ppm, most preferably from about 10 to about 150 ppm. For example, the hindered amine light stabilizer may be added in an amount of from 10 to 100 ppm of the thermoplastic molding composition.

In one embodiment, the additive composition may be made by mixing the dry additive or additives in the form of a powder with a liquid organic carrier, typically in a range of from about 1 to about 85 wt %, more usually in the range of from about 30 to about 50 wt %. The resulting additive composition comprising the hindered amine stabilizer and the acetaldehyde scavenger uniformly dissolved or dispersed in the liquid carrier can then be added to the thermoplastic polymer in ranges from about 0.0001% by weight to about 7% by weight, for example, from 0.01% by weight up to about 5% by weight, based upon the weight of thermoplastic polymer component used.

It may not be desirable to use higher concentrations of the additive as this may interfere with the properties of the thermoplastic polymer material.

In another aspect of the present invention there is provided a method of making a molded article from a colourless or substantially colourless thermoplastic molding composition which comprises:
(a) providing a colourless or substantially colourless thermoplastic molding composition comprising polyethylene terephthalate;
(b) admixing with the thermoplastic molding composition at least one hindered amine light stabilizer and at least one acetaldehyde scavenger;
(c) heating the colourless or substantially colourless thermoplastic molding composition; and
(d) molding the hot colourless or substantially colourless thermoplastic molding composition so as to form a molded article.

Typically the colourless or substantially colourless thermoplastic molding composition is injection molded to form a bottle preform and the resulting bottle preform is then blow molded to form a bottle.

The invention further provides a method of a making a blow molded bottle from a polyethylene terephthalate molding composition which comprises:
(i) providing a colourless or substantially colourless polyethylene terephthalate molding composition;
(ii) admixing with the polyethylene terephthalate molding composition at least one hindered amine light stabilizer and at least one acetaldehyde scavenger;
(iii) heating the colourless or substantially colourless polyethylene terephthalate molding composition;
(iv) extruding the hot colourless or substantially colourless polyethylene terephthalate molding composition so as to form a bottle preform; and
(v) blow molding the bottle preform at a blow molding temperature so as to form a colourless or substantially colourless bottle;

Also provided in accordance with another aspect of the present invention is a method of making a useful article which comprises:
(A) providing a colourless or substantially colourless thermoplastic molding composition comprising polyethylene terephthalate;
(B) admixing with the thermoplastic molding composition at least one hindered amine light stabilizer and at least one acetaldehyde scavenger;
(C) forming a colourless or substantially colourless molded article by a procedure including heating the colourless or substantially colourless thermoplastic molding composition;
(D) after use of the molded article, subjecting the material of the molded article to recycling steps which include subjecting the material of the molded article to elevated temperature conditions for a prolonged period of time; and
(E) re-forming the thus treated material into a useful article.

Also provided in accordance with another aspect of the present invention is a method of making a useful article which comprises:
(A) providing a colourless or substantially colourless thermoplastic molding composition comprising polyethylene terephthalate and an acetaldehyde scavenger as an additive;
(B) forming a colourless or substantially colourless molded article by a procedure including heating the colourless or substantially colourless thermoplastic molding composition;
(C) after use of the molded article, admixing with the material of the molded article at least one hindered amine light stabilizer;
(D) subjecting the resulting material of the molded article to recycling steps which include subjecting the material of the molded article to elevated temperature conditions for a prolonged period of time; and
(E) re-forming the thus treated material into a useful article.

In the re-forming step (E) typically techniques that can be used include molding, extrusion, and other conventional processes for making articles of plastics materials, including bottles and fibres.

In such a method the colourless or substantially colourless thermoplastic (i.e. polyethylene terephthalate) molding composition in step (B) can be injection molded to form a bottle preform and then the resulting bottle preform can be blow molded to form a bottle.

The invention further provides a method of making an article from a colourless or substantially colourless thermoplastic molding composition that comprises:
(I) providing a colourless or substantially colourless thermoplastic molding composition comprising recycled colourless or substantially colourless thermoplastic material, said recycled colourless or substantially colourless thermoplastic material containing at least one acetaldehyde scavenger;
(II) admixing with the thermoplastic molding composition an additive comprising a hindered amine light stabilizer; and
(III) extruding the resultant composition to form said article.

The article of step (III) may be a molded article, such as a bottle preform, or a fibre or any other useful article, such as a tube, a crate, or the like.

Whilst a number of the aspects of the present invention utilise a molding composition/polyethylene terephthalate which is preferably colourless or substantially colourless, a coloured molding composition may also be used. Preferably, should a coloured molding composition be used, it will be of a blue colour.

Polyethylene terephthalate is hygroscopic and after a period of approximately one year it is noticeable that preforms made of polyethylene terephthalate have taken up moisture from the air. Therefore, prior to the injection molding process, polyethylene terephthalate granules for use in the invention are preferably dried for at least about 6 hours at from about 160° C. to about 190° C., in a procedure that gives a slightly tactile product. The polyethylene terephthalate granules are transferred directly from the drier to the hopper of the injection-molding machine. The hindered amine light stabilizer can then be added to and mixed with the thermoplastic polymer granules upon charging to the hopper. The injection molding process typically occurs at between about 260° C. and about 285° C., more preferably at about 270° C., and the thermoplastic polymer material has a dwell time within the machine of less than 1 minute. Once the preform has been blow molded into an appropriate article, said article may be recycled by a suitable procedure which includes use of temperatures of up to about 300° C. or greater and dwell times up to or in excess of 5 minutes, and sometimes for many hours.

The invention is further illustrated in the following examples with reference to the accompanying figures in which:

FIGS. 1 to 4 show specific examples of hindered amide light stabilizers; and

FIGS. 5 to 7 are plots of % transmission vs wavelength (in nm) for various samples.

The following materials are referred to hereinafter:

Anthranilamide—an acetaldehyde scavenging agent;

VORIDIAN 9921 w—a copolymer PET obtained from Eastman Chemical Company;

CHIMASSORB 944—an oligomeric hindered amine light stabilizer of molecular weight (Mn) 2000-3000 obtained from Ciba Speciality Chemicals (Compound VII in FIG. 2);

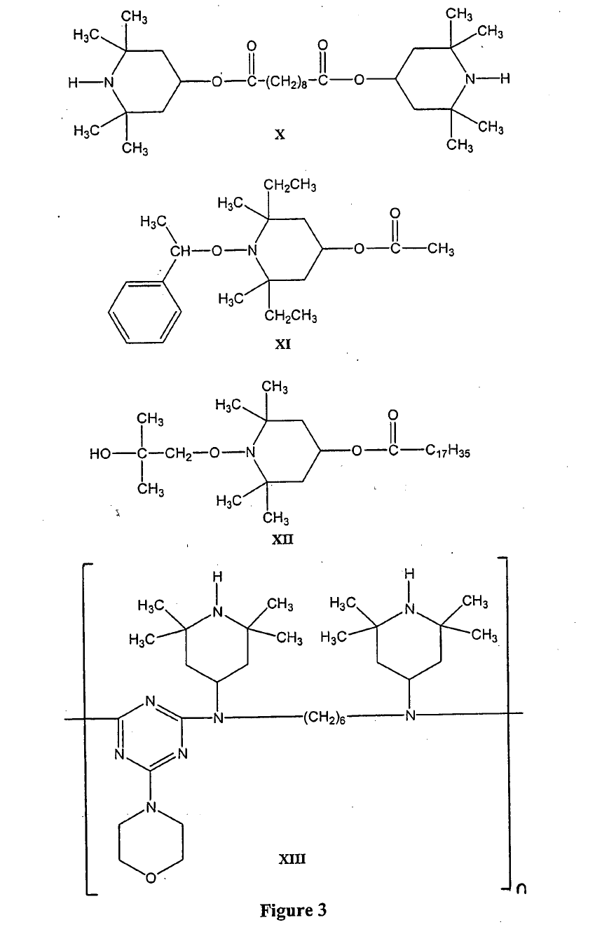

CYASORB UV-3346—a hindered amine light stabilizer of molecular weight about 1600 obtained from Cytec Industries Inc (compound XIII in FIG. 3);

CLEARTUF P82—a polyethylene terephthalate obtained from M&G Group.

Voridian AA reducer—an acetaldehyde reducing formulation from Viridian (referred to as Voridian LMC) containing low molecular weight polyamide;

Tinuvin 622 LD—a powdered oligomeric hindered amine light stabilizer of molecular weight (Mn) 3100-4000 obtained from Ciba Speciality Chemicals (Compound IV in FIG. 1);

MXD6—a polyamide obtained from Mitsubishi Chemical Company;

HALS—refers to “hindered amine light stabilizer(s)”.

### EXAMPLE 1

Anthranilamide acetaldehyde scavenging agent and CHIMASSORB 944 were incorporated at levels detailed in Table 1 into VORIDIAN 9921w polyethylene terephthalate (PET) resin which was molded into a 35 g weight bottle blowing preform using a HUSKY injecting molding machine. The preform was then transferred to a bottle-blowing machine, reheated by an infrared lamp and stretch blown into a 1 litre bottle.

The blown bottle was then ground to fragments and washed with hot water, to simulate the recycle process. After washing the fragments of simulated recycled PET were dried by heating them at approximately 160° C. for five (5) hours and were then extruded at 270° C. using a laboratory extrusion rig and cut into granules.

The experimental recycled PET granules were then crystallised by holding at 180° C. for six (6) hours and then transferred to a batchwise rotation vacuum solid state polymerisation machine. During the Solid State Polymerisation (SSP) process the recycled PET granulate was first subjected to a temperature of 220° C. for sixteen (16) hours and then allowed to cool to below a temperature of 170° C.

The simulated recycled PET granulate was then injection molded into 2.5 mm thick plaque using a BOY 22M injecting molding machine in order to prepare samples for optical analysis.

The % light transmission at the wavelengths 450 nm and 550 nm was determined using a MINOLTA Spectrophotometer CM-3700d and results are provided in Table 2.

TABLE 1

| | | Acetaldehyde Scavenger | | HALS | |
|---|---|---|---|---|---|
| | | | Amount | | Amount |
| | | | based on | | based on |
| Example | PET | | weight of | | weight of |
| No | Identity | Identity | PET (wt %) | Identity | PET (wt %) |
| 1 | VORIDIAN | Anthranilamide | 0.033 | CHIMASSORB | 0.006 |
| | 992lw | | | 944 | |
| C1 | VORIDIAN | Anthranilamide | 0.033 | — | — |
| | 992lw | | | | |
| 2 | VORIDIAN | Anthranilamide | 0.033 | CYASORB UV- | 0.006 |
| | 992lw | | | 3346 | |
| 3 | Cleartuf | Anthranilamide | 0.033 | CHIMASSORB | 0.006 |
| | P82 | | | 944 | |
| C2 | Cleartuf | — | — | — | — |
| | P82 | | | | |
| C3 | Cleartuf | Anthranilamide | 0.033 | — | — |
| | P82 | | | | |

### EXAMPLE C1

The procedure of Example 1 was generally followed except that the CHIMASSORB 944 was omitted as summarised in Table 1. The % light transmission at the wavelengths 450 nm and 550 nm was determined in the manner described in Example 1 for a plaque prior to the simulated recycle process of Example 1 and also after the simulated recycle process. Results are summarised in Table 2.

TABLE 2

| | | |
|---|---|---|
| Composition | | |
| Examined | Time of | % TRANSMISSION |

| (Example No) | Examination | @ 450 nm | @550 nm |
|---|---|---|---|
| 1 | After simulated | 74 | 81 |
| | recycle process | | |
| C1 | Prior to simulated | 79 | 84 |
| | recycle process | | |
| C1 | After simulated | 71 | 79 |
| | recycle process | | |

The increased use of the acetaldehyde reducing agent anthranilamide in PET used to blow bottles has been found to cause a reduction in the light transmission and an increase in the yellow tint of PET when the bottles are recycled. The addition of Chimassorb 944 (Hindered Amine Light Stabilizer) in addition to the anthranilamide significantly reduces the loss of transparency.

### EXAMPLE 2

By a process analogous to Example 1, CYASORB UV-3346 was incorporated in an anthranilamide/PET formulation as detailed in Table 1. Results showed that the CYASORB had a similar effect to the HALS of Example 1.

### EXAMPLE 3 AND COMPARATIVE EXAMPLES C2 AND C3

In this example the acetaldehyde reducing properties of HALS in conjunction with conventional acetaldehyde reducers/scavengers was demonstrated.

Preparation of Experimental Samples—Three parallel experiments were carried out. The experimental procedure varied only in the number and level of acetaldehyde reducer/scavenger and HALS agents added to the commercial PET, Cleartuf P82, as detailed in Table 1.

In the examples, Cleartuf P82 polyethylene terephthalate was loaded into a commercial injection-molding machine (Netstal HP3500) and any additives were incorporated. Each mixer charge was injection molded into a 47 g weight bottle blowing preforms. Samples were taken from each of the experimental preforms and set aside for individual examination for acetaldehyde content, in the manner described below.

Acetaldehyde Analysis—Each sample was immersed in liquid nitrogen and subsequently ground down by Retsch grinder to a particle size less than 1 mm and subjected to chromatographic analysis for free acetaldehyde concentration using a Perkin Elmer XL gas chromatograph with FID detector. Pure acetaldehyde (99.5%) was obtained from Sigma Aldrich for calibration purposes.

Results of the analyses for Examples 3, C2 and C3 are provided in Table 3 which show that the addition of CHIMASSORB 944 (Hindered Amine Light Stabilizer) in addition to anthranilamide (acetaldehyde reducing agent) to PET prior to injection molding the PET causes an unexpected further lowering of acetaldehyde level in the injection molded article (bottle pre-form) relative to the anthranilamide alone (28% reduction).

TABLE 3

| Example | COMPOSITION | ACETALDEHYDE | % |
|---|---|---|---|
| No | EXAMINED | LEVEL (ppm) | REDUCTION |
| C2 | PET (Cleartuf P82) | 6.9 | |
| | with no additives | | |
| C3 | PET (Cleartuf P82) | 3.9 | 43 |
| | with 0.033% active | | |
| | Anthranilamide | | |
| 3 | PET with 0.033% | 2.8 | 59.1 |
| | active | | |
| | Anthranilamide + | | |
| | 0.0060% | | |
| | Chimassorb 944 | | |

### EXAMPLES 4 TO 6 AND C4.1, C4.2 AND C4.3

PET was predried and mixed with additives (acetaldehyde scavengers and/or HALS) and the material extruded using a Mapex 20 mm extruder. After extrusion, the material was pelletized and then subjected to Acetaldehyde Analysis in the manner described above. The pellets were then further crystallised, dried and re-extruded again using the Mapex extruder. Pellets produced were then crystallised, dried and subjected to solid state polymerisation. Thereafter, 2.5 mm plaques were prepared as described with reference to Example 1. Details on the compositions and the acetaldehyde % reduction are provided in Table 4.

TABLE 4

| | Acetaldehyde | | | | |
|---|---|---|---|---|---|
| | Scavenger | | HALS | | Acetal- |
| | | Amount | | Amount | dehyde |
| Example | | used | | used | % re- |
| No | Identity | wt % | Identity | wt % | duction |
| C4.1 | — | — | — | — | 0 |
| C4.2 | Anthrani- | 0.0330 | — | — | 47.4 |
| | lamide | | | | |
| 5 | Anthrani- | 0.0330 | Tinuvin 622 | 0.0060 | 70.4 |
| | lamide | | | | |
| C4.3 | Voridian | 0.1500 | — | — | 58.4 |
| | AA | | | | |
| | reducer | | | | |
| 6 | Voridian | 0.1500 | CHIMASSORB | 0.0060 | 65.2 |
| | AA | | 944 | | |
| | reducer | | | | |

### EXAMPLES 7, C5 AND C6

By processes analogous to the process described for Example 4 etc, colour spectrum data was determined for the compositions detailed in Table 5, after the simulated recycle process using a Minolta Spectrophometer CM-3700D. Colour spectrum data and % transmission at 450 nm and 550 nm are provided in Table 6 and the % light transmission over the wavelengths 400 to 700 nm is represented graphically in FIG. 5.

TABLE 5

| | Acetaldehyde Scavenger | | HALS | |
|---|---|---|---|---|
| | | Amount | | Amount |
| | | based on | | based on |
| | | weight | | weight |
| | | of PET | | of PET |
| Example No | Identity | (wt %) | Identity | (wt %) |
| 7 | Anthranilamide | 0.0330 | CYASORB | 0.0060 |
| | | | UV-3346 | |
| C5 | — | — | — | — |
| C6 | Anthranilamide | — | — | — |

TABLE 6

| Example | Colour Spectrum data | | | | | % Transmission | |
|---|---|---|---|---|---|---|---|
| No | L* | a* | b* | C* | h° | 450 nm | 550 nm |
| 7 | 91.90008 | −1.25264 | 8.44944 | 8.5418 | 98.43264 | 71.146 | 80.836 |
| C5 | 93.6646 | −0.6909 | 2.61336 | 2.70318 | 104.8108 | 81.968 | 84.37 |
| C6 | 91.37288 | −1.19754 | 10.77664 | 10.84302 | 96.34708 | 67.288 | 79.822 |

Referring to FIG. 1, it will be noted that for all wavelengths between 400 to about 600 nm, the material of Example 7 transmits more light than for comparative Example C6 which does not include any HALS. As a result, bottles (or the ike) made from the material of Example 7 will appear clear and/or less coloured than bottles made out of the material of Example C6.

Also, the % acetaldehyde reduction was assessed for Example 7 and found to be 54.7% which shows that the material of Example 7 reduces both acetaldehyde and improves light transmission.

### EXAMPLES 8, 9, C7 AND C8

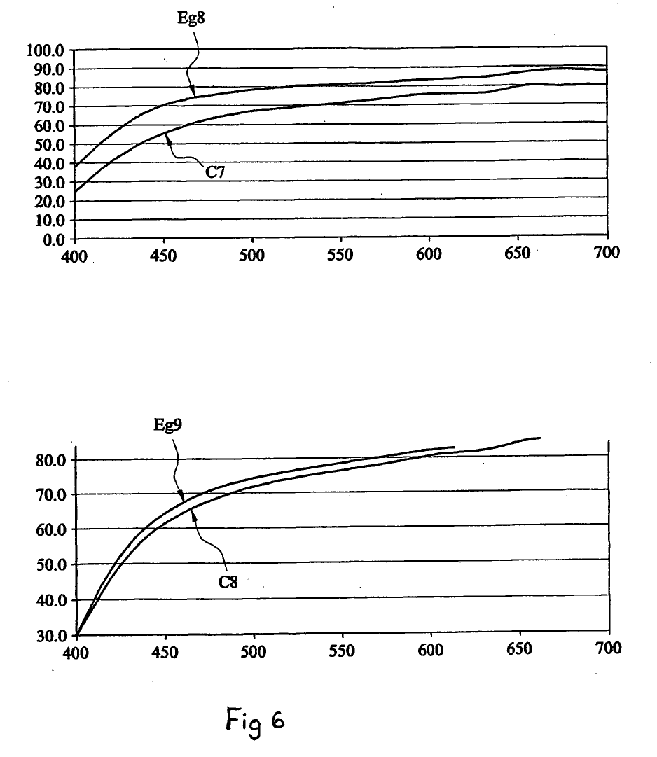

By processes analogous to the process described for Example 4 etc, transmission data was obtained for the compositions detailed in Table 7, after the simulated recycle process, using the Minolta Spectrophometer referred to previously. Results are represented graphically in FIG. 6 (Example 8 and C7) and FIG. 7 (Example 9 and C8).

TABLE 7

| | Acetaldehyde Scavenger | | HALS | |
|---|---|---|---|---|
| | | Amount | | Amount |
| | | based on | | based on |
| Example | | weight of | | weight of |
| No | Identity | PET (ppm) | Identity | PET (ppm) |
| 8 | Anthrani- | 500 | CHIMASSORB | 100 |
| | lamide | | 944 | |
| C7 | Anthrani- | 500 | — | — |
| | lamide | | | |
| 9 | 1,6-bis(2- | 500 | CHIMASSORB | 100 |
| | aminoben- | | 944 | |
| | zamidoyl | | | |
| | hexane) | | | |
| C8 | 1,6-bis(2- | 500 | — | — |
| | aminoben- | | | |
| | zamidoyl | | | |
| | hexane) | | | |

Referring to FIGS. 6 and 7, it will be noted that, in both cases, the addition of HALS resulted in a material which transmitted more light compared to corresponding materials in the absence of the HALS.

### EXAMPLE C9

Plaques were prepared as described with reference to Example 4 etc, using PET and CHIMASSORB 944 HALS (0.006% on weight of PET) in the absence of any acetaldehyde scavenger. In an acetaldehyde analysis, no improvement in the acetaldehyde level was observed using the HALS alone.

### EXAMPLE 10 AND C10

Plaques were prepared as described for Example 4 etc. from Voridian 9221w and the materials referenced in Table 8. The b* values were measured, as shown in the table. It will be noted that the addition of the HALS improves the colour of the plaque.

TABLE 8

| | Acetaldehyde | | | | |
|---|---|---|---|---|---|
| | Scavenger | | HALS | | |
| | | Amount | | Amount | |
| | | based on | | based on | |
| Exam- | | weight of | | weight of | |
| ple | Iden- | PET ppm | | PET ppm | |
| No | tity | wt % | Identity | wt % | b* |
| 10 | MXD6 | 0.15 | CHIMASSORB | 0.006 | 6.276125 |
| | | | 944 | | |
| C10 | MXD6 | 0.15 | — | — | 7.077025 |

### Discussion

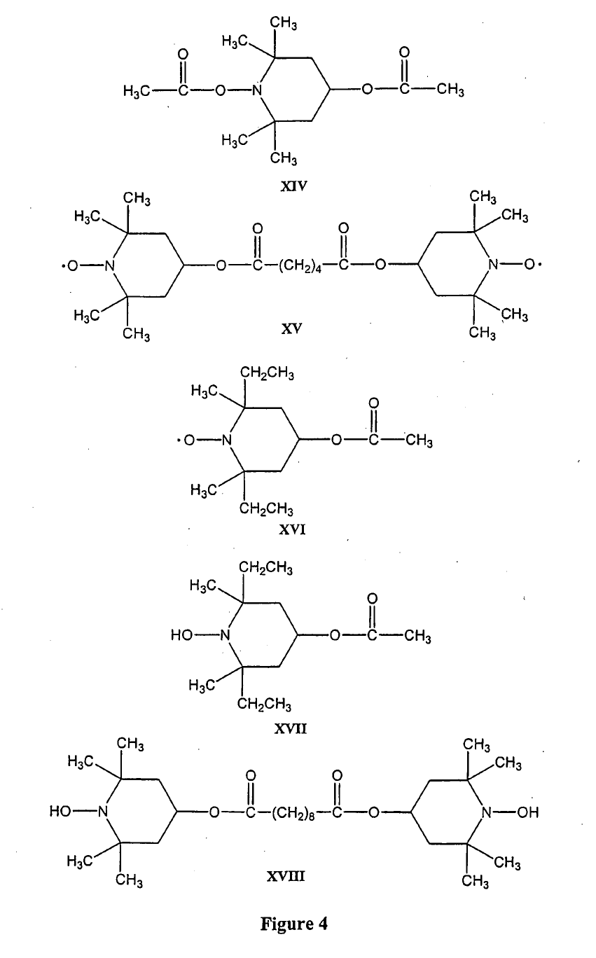

The results show that the addition of a HALS to a PET and acetaldehyde scavenger composition leads to a surprising improvement in the light transmission of the material after a simulated recycle process (see Table 2) (and compare Example 1 and C1 after a simulated recycle process; also compare Example 7 with Examples C5 and C6 and FIG. 4 to 6). The improvement in transmission is clearly shown in the figures. Also, Example 7 shows both an improvement in the transmission and a reduction in acetaldehyde content.

The ability to improve transmission and/or transmission allows more flexibility in toning options, especially the use of blue toning.

Furthermore, the addition of a HALS alone was found to provide no improvement in the reduction of acetaldehyde content of a PET when added to the PET alone (see Example C9). The addition of an acetaldehyde scavenger alone provides a clear reduction in the acetaldehyde content of a PET after a simulated recycle process (compare Examples 3 and C2 and C3. The inclusion of a HALS in a composition comprising PET and acetaldehyde scavenger appears to act synergistically with the acetaldehyde scavenger resulting in a surprising reduction in the acetaldehyde content of a PET after a simulated recycle (compare Examples C3 and 3).

1-22. (canceled)

23. A product comprising a composition which comprises polyethylene terephthalate, a hindered amine light stabilizer and an acetaldehyde scavenger.

24. The product according to claim 23, wherein said product comprises recycled polyethylene terephthalate.

25. The product according to claim 23, wherein said product is in the form of pellets or granules.

26. The product according to claim 23, wherein said product comprises a molded article.

27. The product according to claim 23, wherein said product comprises a preform for a receptacle.

28. The product according to claim 23, wherein said product comprises a bottle.

29. The product according to claim 23, wherein said hindered amine light stabilizer includes a moiety I or II 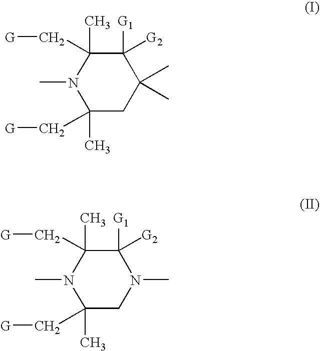
wherein
G is hydrogen or methyl, and
G₁ and G₂ are hydrogen, methyl or together are oxygen.

30. (canceled)

31. The product according to claim 23, wherein said hindered amine light stabilizer is selected from poly[6-[(1,1,3,3-tetramethylbutyl)amino]1,3,5-triazine-2,4-diyl]-[(2,2,6,6-tetramethyl-4-piperidyl)-imino]hexamethylene[(2,2,6,6-tetramethyl-4-piperidyl)imino], poly-[[6-[N-(2,2,6,6-tetramethyl-4-piperidinyl)-n-butylamino]-1,3,5-triazine-2,4-diyl][(2,2,6,6-tetramethyl-4-piperidinyl)imino]-1,6-hexanediyl[2,2,6,6-tetramethyl-4-piperidinyl)imino]]-alpha-[N,N,N′,N′-tetrabutyl-N″-(2,2,6,6-tetramethyl-4-piperidinyl)-N″-[2,2,6,6-tetramethyl-4-piperidinylamino)-hexyl]-[1,3,5-triazine-2,4,6-triamine]omega-N,N,N′,N′-tetrabutyl-1,3,5-triazine-2,4-diamine, sebacic acid, bis(2,2,6,6-tetramethyl-4-piperidyl)ester, and poly(6-morpholino-1,3,5,-triazine-2,4,-diyl)[(2,2,6,6-tetramethyl-4-piperidyl)imino]-hexamethylene-[(2,2,6,6-tetramethyl-4-piperidyl)-imino] and the following compound where m is an integer

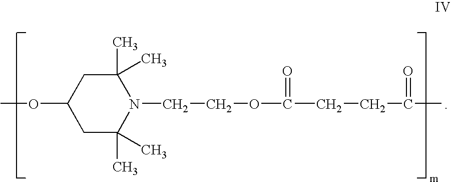

32. The product according to claim 29, wherein said hindered amine light stabilizer includes. said moiety I wherein each G represents a hydrogen atom and G₁ and G₂ represent hydrogen atoms; a —(CH₂CH₂)ₚ— moiety where p is in the range 1 to 10.

33. The product according to claim 23, wherein said hindered amine light stabilizer comprises the following structure wherein m is an integer in a range of 2 to 200:

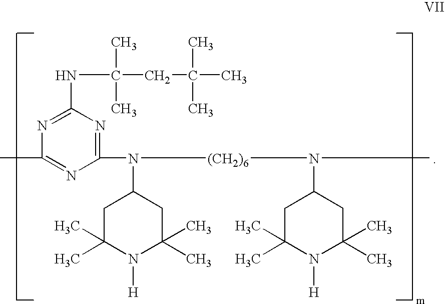

34. The product according to claim 23, wherein said acetaldehyde scavenger includes one or more nitrogen atoms.

35. The product according to claim 23, wherein said acetaldehyde scavenger includes a primary or secondary amine moiety.

36. The product according to claim 23, wherein said acetaldehyde scavenger includes —NH₂, —CONH₂ and a substituted phenyl moiety.

37. The product according to claim 23, wherein said acetaldehyde scavenger is selected from the group consisting of:
a polyamide selected from the group consisting of low molecular weight partially aromatic polyamides having a number average molecular weight of less than 15,000, low molecular weight aliphatic polyamides having a number average molecular weight of less than 7,000, and combinations thereof;
an organic additive compound comprising at least two component molecular fragments, each component molecular fragment comprising at least two hydrogen substituted heteroatoms bonded to carbons of the component molecular fragment, the component molecular fragments each being reactive with acetaldehyde to form water and a resulting organic molecular fragment comprising an unbridged 5- or 6-membered ring including the at least two heteroatoms;
Anthranilamide, 1,8-diaminonaphthalene, Allantoin, 3,4-diaminobenzoic acid, Malonamide, Salicylanilide, 6-amino-1,3-dimethyluracil (DMU), 6-Aminoisocytosine, 6-Aminouracil, and 6-Amino-1-methyluracil.

38. The product according to claim 23, wherein said acetaldehyde scavenger is selected from anthranilamide and 1,6-bis(2-aminobenzamidoyl hexane).

39. The product according to claim 23, wherein the ratio of the weight of said acetaldehyde scavengers to the weight of said hindered amine light stabilizers in said product is at least 2 and less than 30.

40. The product according to claim 39, wherein the ratio is in the range 3 to 8.

41. The product according to claim 23, wherein the amount of acetaldehyde scavenger in the composition is in the range 0.01 to 0.05 wt % and the amount of hindered amine light stabilizer is in the range 0.002 to 0.040 wt %.

42. The product according to claim 26, wherein said molded article includes at least 95 wt % of polyethylene terephthalate.

43. The product according to claim 23, wherein
(a) said hindered amine light stabilizer is selected from the group consisting of poly[6-[(1,1,3,3-tetramethylbutyl)amino]1,3,5-triazine-2,4-diyl]-[(2,2,6,6-tetramethyl-4-piperidyl)-imino]hexamethylene[(2,2,6,6-tetramethyl-4-piperidyl)imino], poly-[[6-[N-(2,2,6,6-tetramethyl-4-piperidinyl)-n-butylamino]-1,3,5-triazine-2,4-diyl][(2,2,6,6-tetramethyl-4-piperidinyl)imino]-1,6-hexanediyl[2,2,6,6-tetramethyl-4-piperidinyl)imino]]-alpha-[N,N,N′,N′-tetrabutyl-N″-(2,2,6,6-tetramethyl-4-piperidinyl)-N″-[2,2,6,6-tetramethyl-4-piperidinylamino)-hexyl]-[1,3,5-triazine-2,4,6-triamine]omega-N,N,N′,N′-tetrabutyl-1,3,5-triazine-2,4-diamine, sebacic acid, bis(2,2,6,6-tetramethyl-4-piperidyl)ester, poly(6-morpholino-1,3,5,-triazine-2,4,-diyl)[(2,2,6,6-tetramethyl-4-piperidyl)imino]-hexamethylene-[(2,2,6,6-tetramethyl-4-piperidyl)-imino] and a compound of the following formula wherein m is an integer 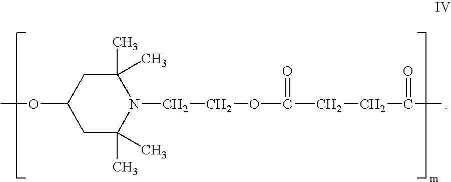
(b) said acetaldehyde scavenger includes a primary or secondary amine moiety;
(c) the ratio of the weight of said acetaldehyde scavenger to the weight of said hindered amine light stabilizer is in the range 3 to 8; and
(d) the amount of said acetaldehyde scavenger in the composition is in the range 0.01 to 0.05 wt % and the amount of said hindered amine light stabilizer is in the range 0.002 to 0.040 wt %.

44. A method of preparing a molding composition comprising polyethylene terephthalate and an acetaldehyde scavenger, the method comprising including a hindered amine light stabilizer as an additive in the molding composition, wherein the composition provides an increased degree of light transmission after molding.

45. The method as claimed in claim 44, wherein said hindered amine light stabilizer includes a moiety I or II 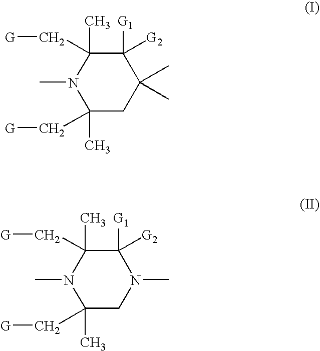
wherein
G is hydrogen or methyl, and
G₁ and G₂ are hydrogen, methyl or together are oxygen.

46. The method as claimed in claim 23, wherein said acetaldehyde scavenger includes one or more nitrogen atoms.

47. The method as claimed in claim 44, wherein the ratio of the weight of acetaldehyde scavenger to the weight of hindered amine light stabilizer is in the range 3 to 8, the amount of acetaldehyde scavenger in the composition is in the range 0.01 to 0.05 wt % and the amount of hindered amine light stabilizer in the composition is in the range 0.002 to 0.040 wt %.
